(19) United States
(12) Patent Application Publication
(10) Pub. No.: US 2025/0296619 A1
(43) Pub. Date: Sep. 25, 2025

(54) Steering system for a wheeled vehicle with at least two steerable wheels and method for controlling in particular the operation of such a steering system

(71) Applicant: TRELLEBORG CARQUEFOU, Carquefou (FR)

(72) Inventors: Frederic MAITAY, RIAILLE (FR); Lionel BOURBIGOT, VERTOU (FR); Jeremy POULLAOUEC, NANTES (FR)

(21) Appl. No.: 18/705,857

(22) PCT Filed: Oct. 27, 2022
(86) PCT No.: PCT/FR2022/052046

§ 371 Date: Feb. 4, 2025

(30) Foreign Application Priority Data
Oct. 28, 2021 (FR) 2111450

(51) Int. Cl. B62D 3/12

(52) U.S. Cl. CPC B62D 3/12

(57) ABSTRACT

A steering system for a wheeled vehicle with at least two steerable wheels has a rack, a steering housing arranged around the rack, a member for driving the rack in a sliding movement inside the housing, and two tie rods having one end coupled to an end of the rack by an articulated connection and one opposite end that can be coupled to one of the steerable wheels of the vehicle. Two bellows each protect an articulated connection and connect a tie rod to the housing. The bellows and the housing delimiting a closed air-tight space. The steering system has a monitoring device having a sensor which determines a parameter representative of the gas tightness of the closed space.

The present invention relates to a steering system for a wheeled machine with at least two steered wheels, and to the method for controlling in particular the operation of such a steering system.

It relates in particular to a steering system for a wheeled machine with at least two steered wheels, said steering system comprising:
a rack,
a steering casing disposed around the rack,
at least one member for driving the axial sliding movement of the rack inside the steering casing,
two steering tie rods having an end that is coupled to an end of the rack by an articulated connection and an opposite end that is couplable to one of the steered wheels of the machine,
two bellows each protecting an articulated connection and each connecting a tie rod to the steering casing, the bellows and the steering casing delimiting a volume that is closed in such a way as to be tight at least with respect to air.

Such a rack-and-pinion steering, in particular for a motor vehicle, is well known to those skilled in the art. As mentioned above, such a steering is produced in a completely tight manner so as to avoid any ingress of fluid in the form of gas or liquid into the steering casing. In the case of a mechanical connection between the rack and the member for controlling the steering, such as a steering wheel, via for example the steering column driven in rotation by the steering wheel, it is easy for the driver to detect a malfunction or a degradation in the operation of the steering resulting, for example, from corrosion. This detection can no longer be effected when there is no mechanical connection between the rack and the member for controlling the steering.

Document DE 10 2012 019 427 describes a steering system with a control unit configured to measure a pressure curve when the wheels are steered to the left or to the right. The characteristics of these pressure curves are analyzed in order to detect any leak in the steering system. Such a steering system is complex.

An aim of the invention is to propose a steering system whose design makes it possible to detect a degradation or a risk of degradation in the operation of the steering independently of how the movement of the member for controlling the steering, such as a steering wheel, is transmitted to the rack.

To this end, a subject of the invention is a steering system for a wheeled machine with at least two steered wheels, said steering system comprising a rack, a steering casing disposed around the rack, at least one member for driving the axial sliding movement of the rack inside the steering casing, two steering tie rods having an end that is coupled to an end of the rack by an articulated connection and an opposite end that is couplable to one of the steered wheels of the machine, two bellows each protecting an articulated connection and each connecting a tie rod to the steering casing, the bellows and the steering casing delimiting a volume that is closed in such a way as to be tight at least with respect to air, characterized in that the steering system comprises a monitoring device, and in that this monitoring device comprises at least one sensor for determining a parameter representative of the tightness, at least with respect to gases, of the closed volume delimited by the bellows and the steering casing. The detection of a loss of gas-tightness of the steering system makes it possible to prevent corrosion in the steering system and consequently the malfunction thereof. Such a detection allows the tightness of the steering system to be continuously monitored in real time.

According to one embodiment of the invention, the closed volume delimited by the bellows and the steering casing is at least partially pre-filled with a gas, called filling gas, and the or at least one of the sensors for determining a parameter representative of the tightness, at least with respect to gases, of the closed volume delimited by the bellows and the steering casing is a sensor for determining the presence or the gas concentration of said filling gas inside the closed volume. This results in simpler monitoring.

According to one embodiment of the invention, the steering system comprises, for the at least partial pre-filling of the volume delimited by the bellows and the steering casing with filling gas, at least one closable gas intake orifice in communication with the volume, said gas intake orifice being in the closed state when said volume is in the pre-filled state. It is thus possible to inject the filling gas through the gas intake orifice, this injection of gas expelling the gas that is already present through the gas discharge orifice.

According to one embodiment of the invention, the or at least one of the sensors for determining a parameter representative of the tightness, at least with respect to gases, of the closed volume delimited by the bellows and the steering casing is disposed at the steering casing. This results in secure positioning of the or of at least one of the sensors. In a variant, the or at least one of the sensors for determining a parameter representative of the tightness, at least with respect to gases, of the closed volume delimited by the bellows and the steering casing is disposed at at least one of the bellows.

According to one embodiment of the invention, the or at least one of the sensors for determining a parameter representative of the tightness, at least with respect to gases, of the closed volume delimited by the bellows and the steering casing is an infrared measurement sensor.

According to one embodiment of the invention, the monitoring device comprises a device for emitting an audible or luminous warning signal and a control unit, said control unit being configured to acquire data supplied by the at least one sensor for determining a parameter representative of the tightness, at least with respect to gases, of the closed volume and to control the device for emitting an audible or luminous warning signal as a function of said data. Thus, a loss of tightness can be reported rapidly to avoid any deterioration of the steering system resulting from a loss of tightness.

According to one embodiment of the invention, the member for driving the axial sliding movement of the rack inside the steering casing is a rotary member in meshed engagement with the rack, and the steering system comprises at least one member for driving the rotation of the member for driving the axial sliding movement of the rack inside the steering casing. The member for driving the axial sliding movement of the rack inside the steering casing, which is a rotary member in meshed engagement with the rack, is generally a toothed member, such as a pinion, or a toothed wheel. The member for driving the rotation of the member for driving the axial sliding movement of the rack inside the steering casing may, for its part, be formed by a steering column, the movement of which is itself driven by a steering wheel or an electric actuator, such as a motor, controlled as a function for example of the actuation of the steering wheel.

A further subject of the invention is a method for controlling a steering system for a wheeled machine with at least two steered wheels, said steering system comprising a rack, a steering casing disposed around the rack, a member for driving the axial sliding movement of the rack inside the steering casing, two steering tie rods having an end that is coupled to an end of the rack by an articulated connection and an opposite end that is couplable to one of the steered wheels of the machine, two bellows each protecting an articulated connection and each connecting a tie rod to the steering casing, the bellows and the steering casing delimiting a volume that is closed in such a way as to be tight at least with respect to air, characterized in that, the steering system being of the aforementioned type, said method comprises at least a step of determining a parameter representative of the tightness, at least with respect to gases, of the closed volume delimited by the bellows and the steering casing.

According to one mode of implementation of the method, prior to the step of determining a parameter representative of the tightness, at least with respect to gases, of the closed volume delimited by the bellows and the steering casing, the method comprises a step of at least partially pre-filling the closed volume with at least one filling gas, and the step of determining a parameter representative of the tightness, at least with respect to gases, of the closed volume delimited by the bellows and the steering casing is a step of determining the presence or the gas concentration of said filling gas inside the closed volume.

According to one mode of implementation of the method, the monitoring device comprising a device for emitting an audible or luminous warning signal and a control unit, said method comprises a step of acquiring, by said control unit, data supplied by the sensor for determining a parameter representative of the tightness, at least with respect to gases, of the closed volume and a step of controlling the device for emitting an audible or luminous warning signal as a function of said data.

### BRIEF DESCRIPTION OF THE DRAWINGS

The invention will be clearly understood on reading the following description of exemplary embodiments, with reference to the appended drawings, in which:

FIG. 1 shows a partial front view of a steering system according to the invention;

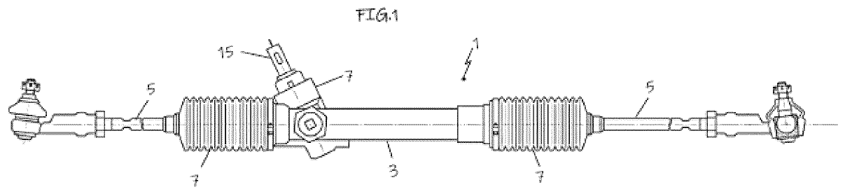

FIG. 2 shows a partial view in section of a steering system according to the invention;

FIG. 3 shows elements of the steering system in the form of blocks.

As mentioned above, the invention relates to a steering system 1 for a wheeled machine (not shown) with at least two steered wheels, such as a motor vehicle.

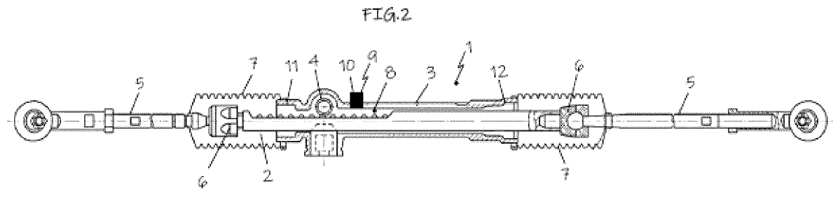

As illustrated in FIG. 2, this steering system 1 comprises a rack 2 with two ends. Specifically, the rack 2 is generally in the form of a longilinear element extending longitudinally between two ends of said element. This longilinear element is provided with a toothing. This rack 2 is generally made of metal.

The steering system 1 also comprises a steering casing 3 disposed around the rack 2. This steering casing 3 forms a tubular envelope that is open at each of its ends. This steering casing 3 surrounds the rack 2, such that the two ends of the rack protrude from said casing 3.

The steering system 1 also comprises a member 4 for driving the axial sliding movement of the rack 2, said member being disposed inside the steering casing 3. In the examples shown, this member 4 for driving the axial sliding movement of the rack 2 inside the steering casing 3 is a rotary member, in particular a toothed pinion in meshed engagement with the toothing of the rack 2.

This member 4 for driving the axial sliding movement of the rack 2 inside the steering casing 3 is in this case shown in engagement with a steering column 15 as well. This steering column 15 is a rotary column which can be maneuvered with the aid of a steering wheel (not shown). Conventionally, the rotation of the steering wheel drives the rotation of the column 15 and of the toothed pinion and consequently an axial sliding movement of the rack, that is to say parallel to its longitudinal axis, in one direction or the opposite direction, depending on the direction of rotation of the steering wheel.

In a variant, the member 4 for driving the axial sliding movement of the rack 2 inside the steering casing 3 may be driven in rotation by an electric actuator, such as a motor, a cylinder or similar, and the rotation may be controlled from what is referred to as an electric steering wheel.

The steering system 1 also comprises two tie rods 5. Thus, the two ends of the rack protruding from the casing 3 are coupled to the steering tie rods 5 respectively associated with the right and left steered wheels (not shown) of the wheeled machine.

The connection between an end of the rack 2 and a tie rod 5 is an articulated connection 6. Thus, the articulated connection 6 between each end of the rack 2 and the corresponding tie rod 5 is a ball joint connection, referred to as an axial ball joint, produced by an axial ball joint housing secured to the end of the rack and by an axial ball joint pivot with spherical head secured to the tie rod and mounted to rotate in any direction in the axial ball joint housing.

That end of the tie rod 5 which is opposite the end coupled to the rack 2 is couplable to the wheel, in particular to the steering knuckle of the wheel.

Thus, in a manner known per se, the rotation of the steering wheel in one direction or the other, and therefore the corresponding rotation of the steering pinion, is converted into a corresponding translation of the rack which, by way of the tie rods and steering knuckles, itself provokes the orientation of vehicle wheels for a right or left turn.

The steering system 1 also comprises two bellows 7 each protecting one of the articulated connections 6 and each connecting a tie rod 5 to the steering casing 3.

In the examples shown, each bellows comprises a sleeve delimited by a peripheral lateral wall. The sleeve is preferably of cylindrical or cylindrical-conical shape. This sleeve, which is produced from synthetic material, generally by injection-molding or blow-molding, comprises in succession, in the axial direction, at least one first annular end, referred to as large base, capable of forming an end for fastening the bellows to the steering casing 3 to be protected, a part that is deformable in the direction of an elongation or of a shortening of the bellows 7 formed by a succession of coaxial turns, a second annular end, referred to as small base, capable of forming an end for fastening the bellows 7 to a steering tie rod 5.

Taking account of the movability of the rack 2 relative to the steering casing 3 and of the variable orientation of the tie rod 5 relative to the end of the rack 2, the protection of the steering in the region of each axial ball joint is therefore ensured by the bellows 7 which connects the adjacent end of the steering casing 3 to the corresponding tie rod 5 by surrounding the rack end (external to the casing) and the axial ball joint.

The large base of the bellows 7 is fastened around the end of the steering casing 3 by means of a first attachment collar which is tightened around this end. The small base of the bellows 7 is fastened around the tie rod 5 or the axial ball joint pivot by means of a second attachment collar which is tightened around this small base.

The deformable part of the steering bellows 7 allows this bellows to be elongated or shortened depending on the position of the rack 2 relative to the steering casing 3.

The bellows 7 and the steering casing 3 delimit a volume 8 that is closed in such a way as to be tight at least with respect to air. In practice, this volume 8 is closed in such a way as to be tight with respect to fluids, that is to say with respect to gases and with respect to liquids.

To check such a tightness, the steering system 1 comprises a monitoring device 9. This monitoring device 9 comprises at least one sensor 10 for determining a parameter representative of the tightness, at least with respect to gas, of the closed volume 8 delimited by the bellows 7 and the steering casing 3.

Preferably, the closed volume 8 delimited by the bellows 7 and the steering casing 3 is at least partially pre-filled with a gas, called filling gas, and the or at least one of the sensors 10 for determining a parameter representative of the tightness, at least with respect to gases, of the volume 8 delimited by the bellows 7 and the steering casing 3 is a sensor for determining the presence or the gas concentration of said filling gas inside the closed volume 8.

To allow the volume 8 to be at least partially pre-filled with filling gas in this way, the steering system 1 comprises at least one closable gas intake orifice 11, and possibly a closable gas discharge orifice 12, in communication with the volume 8, the gas intake orifice 11 and the gas discharge orifice 12, when it is present, being in the closed state when the volume 8 is in the pre-filled state.

Thus, during the manufacture of the steering system, the gas intake orifice 11 and the gas discharge orifice 12 which are in communication with the volume 8, that is to say which open out into the volume 8, are open. A filling gas is injected into the volume 8 through the gas intake orifice 11 and expels, through the gas discharge orifice 12, the gas already contained in the volume 8.

When it is considered that this filling gas has been sufficiently injected, the gas intake orifice 11 and the gas discharge orifice 12 are closed in a tight manner and the sensor or sensors 10 for determining a parameter representative of the tightness, at least with respect to gas, of the closed volume 8 can then supply information relating to the presence or to the gas concentration of said filling gas in the volume 8.

In the examples shown, the sensor 10 for determining a parameter representative of the tightness, at least with respect to gases, of the closed volume delimited by the bellows 7 and the steering casing 3 is disposed at the steering casing 3.

In a variant, this sensor 10 for determining a parameter representative of the tightness, at least with respect to gases, of the volume 8 delimited by the bellows 7 and the steering casing 3 may be disposed at a bellows 7.

Thus, the or at least one, preferably each bellows 7 may comprise for example an end piece housing said sensor 10.

In the examples shown, the sensor is an infrared measurement sensor.

The detection principle is based on the absorption of infrared radiation by the filling gas. Other measurement principles may be used and chemical sensors or sensors incorporating semiconductors may be utilized for such measurements. Such sensors will not be described in detail because they are well known to those skilled in this art.

The filling gas may be a gas that is already present in the air or what is referred to as a neutral or noble gas such as argon or others.

The data from the sensor can be processed in a great variety of ways. These data from the sensor may be, for example, communicated to a remote terminal which is used during maintenance of the steering system and on which said data are displayed.

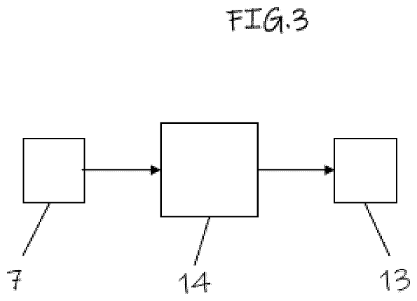

In a variant and as shown in FIG. 3, the monitoring device 9 may comprise a device 13 for emitting an audible or luminous warning signal and a control unit 14.

The control unit 14 is configured to acquire the data supplied by the sensor or sensors 10 for determining a parameter representative of the tightness, at least with respect to gas, of the closed volume 8 and to control the device 13 for emitting an audible or luminous warning signal as a function of said data.

In practice, the measured value may be compared, for example, with a stored threshold value, and a warning is emitted depending on the result of the comparison.

The control unit 14 is in the form of an electronic computer system which comprises, for example, a microprocessor and a working memory. According to a particular aspect, the control unit may be in the form of a programmable controller.

In other words, the functions and steps described may be implemented in the form of a computer program or via hardware components (for example programmable gate arrays). In particular, the functions and steps performed by the control unit or the modules thereof may be performed by sets of instructions or computer modules implemented in a processor or controller or may be performed by dedicated electronic components or components of the programmable logic circuit (or FPGA standing for field-programmable gate array) type or of the application-specific integrated circuit (ASIC) type. It is also possible to combine computer parts and electronic parts.

When it is specified that the unit or means or modules of said unit are configured to perform a given operation, this means that the unit comprises computer instructions and the corresponding means of execution to allow said operation to be performed and/or that the unit comprises corresponding electronic components.

The method for controlling such a steering system 1 therefore comprises at least a step of determining a parameter representative of the tightness, at least with respect to gas, of the closed volume 8 delimited by the bellows 7 and the steering casing 3.

This step is preceded by a step of at least partially filling the volume 8 with at least one filling gas, and the step of determining a parameter representative of the tightness, at least with respect to gas, of the closed volume 8 delimited by the bellows 7 and the steering casing 3 is a step of determining the presence or the gas concentration of said filling gas inside the closed volume 8.

The step of determining the presence or the gas concentration of the filling gas may be followed by a step of acquiring, by the control unit 14, data supplied by the sensor 10 for determining a parameter representative of the tightness, at least with respect to gas, of the closed volume 8 and by a step of controlling the device 13 for emitting an audible or luminous warning signal as a function of said data.

1. A steering system for a wheeled machine with at least two steered wheels, said steering system comprising:
a rack,
a steering casing disposed around the rack,
at least one member for driving the axial sliding movement of the rack inside the steering casing,
two steering tie rods having an end that is coupled to an end of the rack by an articulated connection and an opposite end that is couplable to one of the steered wheels of the machine,
two bellows each protecting an articulated connection and each connecting a tie rod to the steering casing, the bellows and the steering casing delimiting a volume that is closed in such a way as to be tight at least with respect to air,
wherein the steering system comprises a monitoring device, and in that this monitoring device comprises at least one sensor for determining a parameter representative of the tightness, at least with respect to gases, of the closed volume delimited by the bellows and the steering casing.

2. The steering system as claimed in claim 1, wherein the closed volume delimited by the bellows and the steering casing is at least partially pre-filled with a gas, called filling gas, and in that the or at least one of the sensors for determining a parameter representative of the tightness, at least with respect to gases, of the closed volume delimited by the bellows and the steering casing is a sensor for determining the presence or the gas concentration of said filling gas inside the closed volume.

3. The steering system as claimed in claim 2, wherein the steering system comprises, for the at least partial pre-filling of the volume delimited by the bellows and the steering casing with filling gas, at least one closable gas intake orifice in communication with the volume, said gas intake orifice being in the closed state when said volume is in the pre-filled state.

4. The steering system as claimed in claim 1, wherein the or at least one of the sensors for determining a parameter representative of the tightness, at least with respect to gases, of the closed volume delimited by the bellows and the steering casing is disposed at the steering casing.

5. The steering system as claimed in claim 1, wherein the or at least one of the sensors for determining a parameter representative of the tightness, at least with respect to gases, of the closed volume delimited by the bellows and the steering casing is an infrared measurement sensor.

6. The steering system as claimed in claim 1, wherein the monitoring device comprises a device for emitting an audible or luminous warning signal and a control unit, said control unit being configured to acquire data supplied by the at least one sensor for determining a parameter representative of the tightness, at least with respect to gases, of the closed volume and to control the device for emitting an audible or luminous warning signal as a function of said data.

7. The steering system as claimed in claim 1, wherein the member for driving the axial sliding movement of the rack inside the steering casing is a rotary member in meshed engagement with the rack, and in that the steering system comprises at least one member for driving the rotation of the member for driving the axial sliding movement of the rack inside the steering casing.

8. A method for controlling a steering system for a wheeled machine with at least two steered wheels, said steering system comprising a rack, a steering casing disposed around the rack, a member for driving the axial sliding movement of the rack inside the steering casing, two steering tie rods having an end that is coupled to an end of the rack by an articulated connection and an opposite end that is couplable to one of the steered wheels of the machine, two bellows each protecting an articulated connection and each connecting a tie rod to the steering casing, the bellows and the steering casing delimiting a volume that is closed in such a way as to be tight at least with respect to air, wherein the steering system being as claimed in claim 1, said method comprises at least a step of determining a parameter representative of the tightness, at least with respect to gases, of the closed volume delimited by the bellows and the steering casing.

9. The control method as claimed in claim 8, wherein, prior to the step of determining a parameter representative of the tightness, at least with respect to gases, of the closed volume delimited by the bellows and the steering casing, the method comprises a step of at least partially pre-filling the volume with at least one filling gas, and in that the step of determining a parameter representative of the tightness, at least with respect to gases, of the closed volume delimited by the bellows and the steering casing is a step of determining the presence or the gas concentration of said filling gas inside the closed volume.

10. The control method as claimed in claim 8, wherein, the monitoring device comprising a device for emitting an audible or luminous warning signal and a control unit, said method comprises a step of acquiring, by said control unit, data supplied by the sensor for determining a parameter representative of the tightness, at least with respect to gases, of the closed volume and a step of controlling the device for emitting an audible or luminous warning signal as a function of said data.
